(19) United States
(12) Patent Application Publication
(10) Pub. No.: US 2023/0274267 A1
(43) Pub. Date: Aug. 31, 2023

(54) IN-APP TRANSACTION VALIDATION

(71) Applicant: Snap Inc., Santa Monica, CA (US)

(72) Inventors: Virgil L. Archer, III, Los Angeles, CA (US); Hao He, Clyde Hill, WA (US); Allen Huang, Redondo Beach, CA (US); Krish Jayaram, Santa Monica, CA (US); Deng Liu, Millbrae, CA (US); Ngoan Nguyen, Huntington Beach, CA (US); Bernardo Perez, Los Angeles, CA (US); Aung Win Thein, Carson, CA (US); Khoi Tran, West Hills, CA (US); Colin Usala, Lake Forest Park, WA (US)

(21) Appl. No.: 18/168,905

(22) Filed: Feb. 14, 2023

Related U.S. Application Data
(60) Provisional application No. 63/310,005, filed on Feb. 14, 2022.

(51) Int. Cl. G06Q 20/38; G06Q 20/40; G06F 3/0484; G06F 3/04817; G06F 3/0482

(52) U.S. Cl. CPC G06Q 20/3821; G06F 3/0482; G06F 3/0484; G06F 3/04817; G06Q 20/4014; G06Q 2220/00

(57) ABSTRACT

A system to perform operations that include: executing an application at a client device; presenting a graphical user interface (GUI) associated with the application at the client device, the GUI including an icon to initiate a request for a payment to a merchant; receiving an input that selects the icon from the client device; accessing a user profile associated with the client device in response to the request to initiate the payment, the user profile comprising user profile data; generating a payment credential based on the user profile data from the user profile; authorizing the payment to the merchant based on the payment credetitial; executing the payment to the merchant at the client device, within the application, based on the authorizing the payment; and passing a payment token to the merchant responsive to the executing the payment to the merchant within the application, the payment token comprising a validation.

### CLAIM OF PRIORITY

This patent application claims the benefit of priority to U.S Application Serial No 63/310,005, filed Feb. 14, 2022, which is incorporated by reference herein in its entirety.

### BACKGROUND

During a transaction between two parties, each party typically wants assurances as to the authenticity of the identity, permissions and/or the data relating to the other party so as to avoid a variety of problems, including fraud and transaction repudiation. Such transactions can be either payment or non-payment in nature. In non-payment transactions, for example, one party may want to confirm the identity of the other party before disclosing certain information (e.g., in the exchange of non-payment data such as personal information, confidential information, or similar information). On the other hand, during a payment transaction using a payment instrument (e.g., a credit, debit, or stored value card), it is important to verify a user’s ownership of an account to avoid unauthorized use of the payment instrument. Also, during payment transactions, it may be necessary to communicate payment information (such as an account number or the like) to be used in performing the transaction. For purposes of this application, references to “transactions” shall include both payment and non-payment transactions.

Authentication procedures during transactions when two parties are interacting in each other’s physical presence (referred to as “in-person” transactions) can involve verifying that the signature of a user matches the signature on a piece of identification or a payment instrument, such as a credit card. Another authentication procedure involves verifying that a photograph contained in a form of identification, such as a driver’s license, matches the physical appearance of the user. However, transactions initiated and accomplished over a public network, such as the Internet, are riskier because the “in-person” authentication procedures cannot be performed. Such transactions can be initiated from devices such as but not limited to mobile phones, “smartphones,” Internet-connected computers or terminals, or Personal Digital Assistants (PDAs).

Given the continuing increase in the number of transactions that take place over public networks, it is important to provide methods to authenticate the identity and profile data of individuals. Authentication techniques during such transactions will reduce the levels of fraud and disputes, which in turn will reduce the costs associated with each of these events.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings in which:

FIG. 1 is a diagrammatic representation of a networked environment in which the present disclosure may be deployed, in accordance with some examples.

FIG. 2 is a diagrammatic representation of a messaging system, in accordance with some examples, that has both client-side and server-side functionality.

FIG. 3 is a flowchart depicting a method for facilitating a secure transaction, in accordance with one embodiment.

FIG. 4 is a flowchart depicting a method for facilitating a secure transaction, in accordance with one embodiment.

FIG. 5 is a flowchart depicting a method for facilitating a secure transaction, in accordance with one embodiment.

FIG. 6 illustrates a flow diagram depicting a method for facilitating a secure transaction, in accordance with one embodiment.

FIG. 7 illustrates an interface flow diagram depicting a method for facilitating a secure transaction, in accordance with one embodiment.

FIG. 8 illustrates an interface flow diagram depicting a method for facilitating a secure transaction, in accordance with one embodiment.

FIG. 9 is a diagrammatic representation of a machine in the form of a computer system within which a set of instructions may be executed for causing the machine to perform any one or more of the methodologies discussed herein, in accordance with some examples.

FIG. 10 is a block diagram showing a software architecture within which examples may be implemented.

FIG. 11 is a diagrammatic representation of a processing environment, in accordance with some examples.

### DETAILED DESCRIPTION

As discussed above, it is important to provide methods to authenticate the identity and profile data of individuals, and authentication techniques during such transactions will reduce the levels of fraud and disputes, which in turn will reduce the costs associated with each of these events. A system is disclosed to facilitate user transactions within an application environment, wherein the system utilizes user profile data for the purposes of authenticating the transaction.

According to certain example embodiments, a transaction validation system is configured to perform operations that include: executing an application at a client device; presenting a graphical user interface (GUI) associated with the application at the client device, the GUI including an icon to initiate a request for a payment to a merchant; receiving an input that selects the icon from the client device; accessing a user profile associated with the client device in response to the request to initiate the payment, the user profile comprising user profile data; generating a payment credential based on the user profile data from the user profile; authorizing the payment to the merchant based on the payment credential; executing the payment to the merchant at the client device, within the application, based on the authorizing the payment; and passing a payment token to the merchant responsive to the executing the payment to the merchant within the application, the payment token comprising a validation.

In some example embodiments, the user profile associated with the client device may be hosted within a database associated with the transaction validation system. The transaction validation system may maintain a database comprising one or more payment methods and credentials associated with the user profile Accordingly, the transaction validation system may retrieve a payment method and its corresponding validation credentials responsive to receiving a request from a client device, in order to execute a payment to a merchant. For example, the payment methods may include one or more credit cards (i.e., credit card numbers), wherein the validation credentials may include name and address information that correspond with each of the one or more credit cards.

In some example embodiments, responsive to receiving the input that selects the icon from the client device, the transaction validation system may present a secondary icon, wherein the user of the client device may confirm a request to execute a transaction by providing an input to select the secondary icon. For example, the input may include a tactile input that comprises a gesture, such as a swiping or taping gesture. Responsive to receiving the input that comprises the gesture, the transaction validation system may perform operations to execute a requested payment to a merchant.

In some embodiments, the transaction validation system may receive a confirmation from the merchant responsive to executing the transaction and transmitting the payment token to the merchant. The transaction validation system may cause display of a presentation of the confirmation at the client device, wherein the confirmation includes an identification of the merchant and one or more transaction attributes.

### Networked Computing Environment

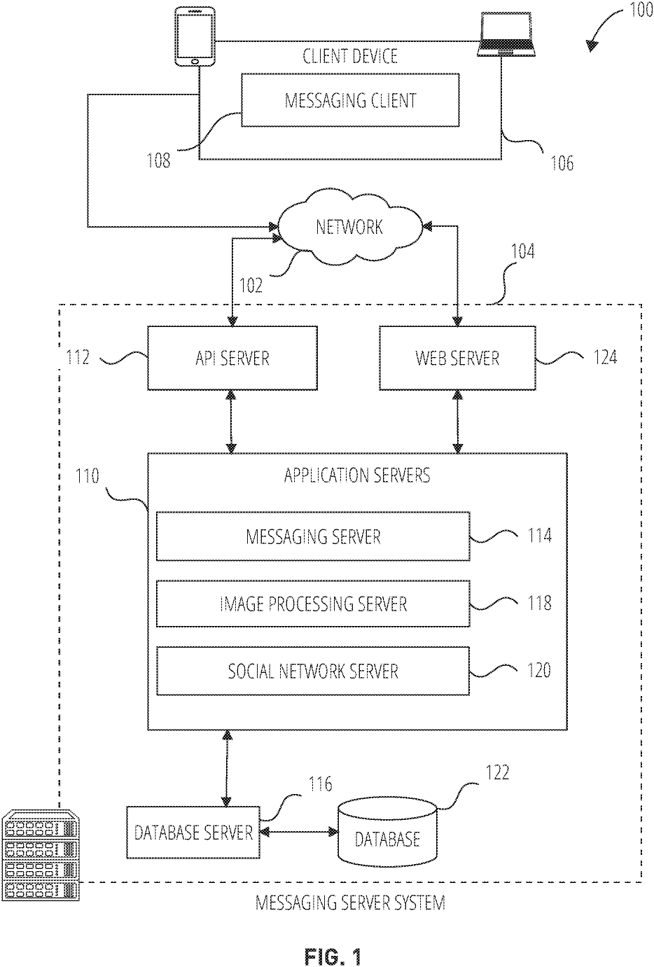

FIG. 1 is a block diagram showing an example messaging system 100 for exchanging data (e.g., messages and associated content) over a network. The messaging system 100 includes multiple instances of a client device 106, each of which hosts a number of applications, including a messaging client 108. Each messaging client 108 is communicatively coupled to other instances of the messaging client 108 and a messaging server system 104 via a network 102 (e.g., the internet).

A messaging client 108 is able to communicate and exchange data with another messaging client 108 and with the messaging server system 104 via the network 102. The data exchanged between messaging client 108, and between a messaging client 108 and the messaging server system 104, includes functions (e.g., commands to invoke functions) as well as payload data (e.g., text, audio, video or other multimedia data).

The messaging server system 104 provides server-side functionality via the network 102 to a particular messaging client 108. While certain functions of the messaging system 100 are described herein as being performed by either a messaging client 108 or by the messaging server system 104, the location of certain functionality either within the messaging client 108 or the messaging server system 104 may be a design choice. For example, it may be technically preferable to initially deploy certain technology and functionality within the messaging server system 104 but to later migrate this technology and functionality to the messaging client 108 where a client device 106 has sufficient processing capacity.

The messaging server system 104 supports various services and operations that are provided to the messaging client 108. Such operations include transmitting data to, receiving data from, and processing data generated by the messaging client 108. This data may include message content, client device information, geolocation information, media augmentation and overlays, message content persistence conditions, social network information, and live event information, as examples. Data exchanges within the messaging system 100 are invoked and controlled through functions available via user interfaces (UIs) of the messaging client 108

Turning now specifically to the messaging server system 104, an Application Program Interface (API) server 112 is coupled to, and provides a programmatic interface to, application servers 110. The application servers 110 are communicatively coupled to a database server 116, which facilitates access to a database 122 that stores data associated with messages processed by the application servers 110. Similarly, a web server 124 is coupled to the application servers 110, and provides web-based interfaces to the application servers 110. To this end, the web server 124 processes incoming network requests over the Hypertext Transfer Protocol (HTTP) and several other related protocols. In certain embodiments, the database 122 may include a decentralized database.

The Application Program Interface (API) server 112 receives and transmits message data (e.g., commands and message payloads) between the client device 106 and the application servers 110. Specifically, the Application Program Interface (API) server 112 provides a set of interfaces (e.g., routines and protocols) that can be called or queried by the messaging client 108 in order to invoke functionality of the application servers 110. The Application Program Interface (API) server 112 exposes various functions supported by the application servers 110, including account registration, login functionality, the sending of messages, via the application servers 110, from a particular messaging client 108 to another messaging client 108, the sending of media files (e.g., images or video) from a messaging client 108 to a messaging server 114, and for possible access by another messaging client 108, the settings of a collection of media data (e.g., story), the retrieval of a list of friends of a user of a client device 106, the retrieval of such collections, the retrieval of messages and content, the addition and deletion of entities (e.g., friends) to an entity graph (e.g., a social graph), the location of friends within a social graph, and opening an application event (e.g., relating to the messaging client 108).

The application servers 110 host a number of server applications and subsystems, including for example a messaging server 114, an image processing server 118, and a social network server 120. The messaging server 114 implements a number of message processing technologies and functions, particularly related to the aggregation and other processing of content (e.g., textual and multimedia content) included in messages received from multiple instances of the messaging client 108. As will be described in further detail, the text and media content from multiple sources may be aggregated into collections of content (eg, called stories or galleries). These collections are then made available to the messaging client 108. Other processor and memory intensive processing of data may also be performed server-side by the messaging server 114, in view of the hardware requirements for such processing.

The application servers 110 also include an image processing server 118 that is dedicated to performing various image processing operations, typically with respect to images or video within the payload of a message sent from or received at the messaging server 114.

The social network server 120 supports various social networking functions and services and makes these functions and services available to the messaging server 114. Examples of functions and services supported by the social network server 120 include the identification of other users of the messaging system 100 with which a particular user has relationships or is “following,” and also the identification of other entities and interests of a particular user.

### System Architecture

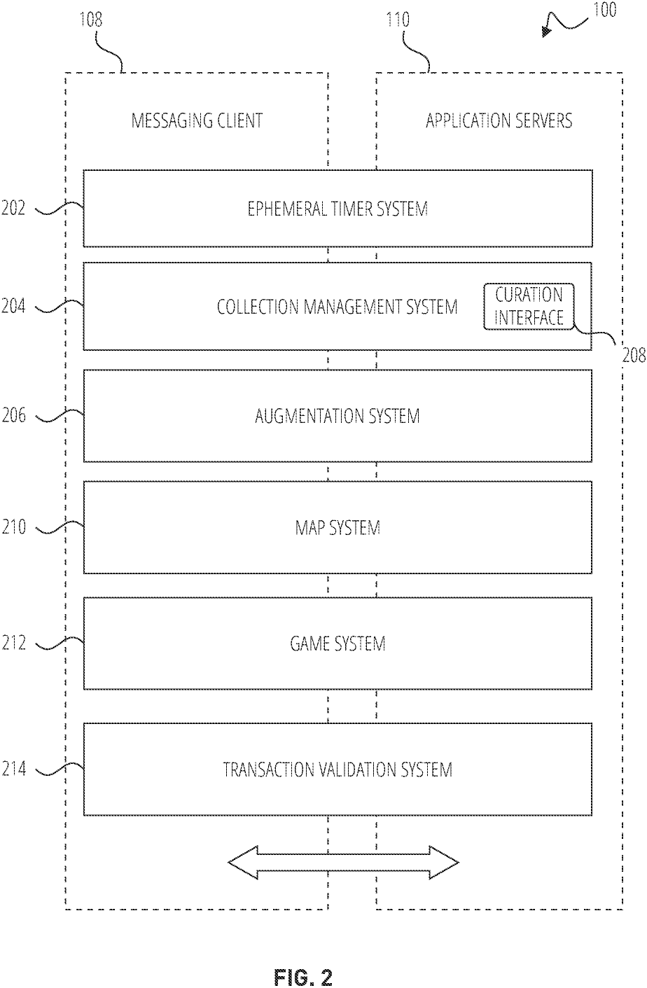

FIG. 2 is a block diagram illustrating further details regarding the messaging system 100, according to some examples. Specifically, the messaging system 100 is shown to comprise the messaging client 108 and the application servers 110. The messaging system 100 embodies a number of subsystems, which are supported on the client-side by the messaging client 108 and on the sever-side by the application servers 110. These subsystems include, for example, an ephemeral timer system 202, a collection management system 204, an augmentation system 206, a map system 210, a game system 212, and a transaction validation system 214.

The ephemeral timer system 202 is responsible for enforcing the temporary or time-limited access to content by the messaging client 108 and the messaging server 114. The ephemeral timer system 202 incorporates a number of timers that, based on duration and display parameters associated with a message, or collection of messages (e.g., a story), selectively enable access (e.g., for presentation and display) to messages and associated content via the messaging client 108. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client 108.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 206 provides various functions that enable a user to augment (e.g., annotate or otherwise modify or edit) media content associated with a message. For example, the augmentation system 206 provides functions related to the generation and publishing of media overlays for messages processed by the messaging system 100. The augmentation system 206 operatively supplies a media overlay or augmentation (e.g., an image filter) to the messaging client 108 based on a geolocation of the client device 106. In another example, the augmentation system 206 operatively supplies a media overlay to the messaging client 108 based on other information, such as social network information of the user of the client device 106. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 106. For example, the media overlay may include text or image that can be overlaid on top of a photograph taken by the client device 106. In another example, the media overlay includes an identification of a location overlay (e.g., Venice beach), a name of a live event, or a name of a merchant overlay (e.g., Beach Coffee House). In another example, the augmentation system 206 uses the geolocation of the client device 106 to identify a media overlay that includes the name of a merchant at the geolocation of the client device 106. The media overlay may include other indicia associated with the merchant. The media overlays may be stored in the database 122 and accessed through the database server 116.

In some examples, the augmentation system 206 provides a user-based publication platform that enables users to select a geolocation on a map and upload content associated with the selected geolocation. The user may also specify circumstances under which a particular media overlay should be offered to other users. The augmentation system 206 generates a media overlay that includes the uploaded content and associates the uploaded content with the selected geolocation.

In other examples, the augmentation system 206 provides a merchant-based publication platform that enables merchants to select a particular media overlay associated with a geolocation via a bidding process. For example, the augmentation system 206 associates the media overlay of the highest bidding merchant with a corresponding geolocation for a predefined amount of time.

The map system 210 provides various geographic location functions, and supports the presentation of map-based media content and messages by the messaging client 108. For example, the map system 210 enables the display of user icons or avatars on a map to indicate a current or past location of “friends” of a user, as well as media content (e.g., collections of messages including photographs and videos) generated by such friends, within the context of a map. For example, a message posted by a user to the messaging system 100 from a specific geographic location may be displayed within the context of a map at that particular location to “friends” of a specific user on a map interface of the messaging client 108. A user can furthermore share his or her location and status information (e.g., using an appropriate status avatar) with other users of the messaging system 100 via the messaging client 108, with this location and status information being similarly displayed within the context of a map interface of the messaging client 108 to selected users.

The game system 212 provides various gaming functions within the context of the messaging client 108. The messaging client 108 provides a game interface providing a list of available games that can be launched by a user within the context of the messaging client 108, and played with other users of the messaging system 100. The messaging system 100 further enables a particular user to invite other users to participate in the play of a specific game, by issuing invitations to such other users from the messaging client 108. The messaging client 108 also supports both the voice and text messaging (e.g., chats) within the context of gameplay, provides a leaderboard for the games, and also supports the provision of in-game rewards (e.g., coins and items).

According to certain example embodiments, the transaction validation system 214 provides functions that include: executing an application at a client device; presenting a graphical user interface (GUI) associated with the application at the client device, the GUI including an icon to initiate a request for a payment to a merchant; receiving an input that selects the icon from the client device; accessing a user profile associated with the client device in response to the request to initiate the payment, the user profile comprising user profile data; generating a payment credential based on the user profile data from the user profile; authorizing the payment to the merchant based on the payment credential; executing the payment to the merchant at the client device, within the application, based on the authorizing the payment; and passing a payment token to the merchant responsive to the executing the payment to the merchant within the application, the payment token comprising a validation.

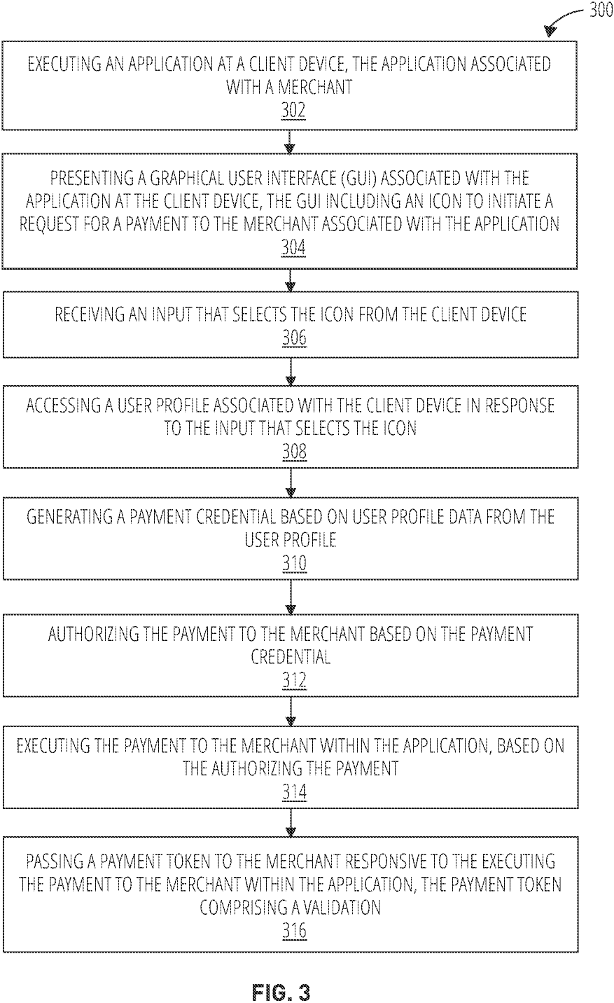

FIG. 3 is a flowchart illustrating operations of a transaction validation system 214 in performing a method 300 for validating a transaction, in accordance with one embodiment. Operations of the method 300 may be performed by one or more subsystems of the messaging system 100 described above with respect to FIG. 2, such as the transaction validation system 214. As shown in FIG. 3, the method 300 includes one or more operations 302, 304, 306, 308, 310, 312, 314, and 316.

At operation 302, the transaction validation system 214 executes an application at a client device 106 responsive to an input received from the client device 106 to execute the application. In some embodiments, the application may be associated with one or more merchants.

At operation 304, a GUI associated with the application is presented at the client device 106, wherein the GUI includes an icon, and wherein selection of the icon may cause the transaction validation system 214 to initiate a request for a transaction with a merchant from among the one or more merchants associated with the application.

At operation 306, the transaction validation system 214 receives an input that selects the icon. Responsive to the input, at operation 308, the transaction validation system 214 accesses a user profile associated with the client device 106, wherein the user profile comprises user profile data. For example, the transaction validation system 214 may maintain a repository, such as the database 122, which comprises one or more payment methods associated with the user, such as credit cards and their corresponding validation credentials. As an illustrative example, a user may provide credit cards and corresponding validation credentials to the transaction validation system 214, and the transaction validation system 214 may maintain the credit cards and corresponding validation credentials within the database 122.

At operation 310, the transaction validation system 214 generates a transaction credential based on the user profile data from the user profile. For example, the user may provide an input that selects a payment method from among the one or more payment methods associated with the user profile, and in response, the transaction validation system 214 may generate a transaction credential based on the validation credentials that correspond with the selected payment method. For example, the validation credentials may include an address or zip code associated with the selected payment method.

At operation 312, the transaction validation system 214 authorizes the transaction with the merchant based on the transaction credential. For example, the transaction validation system 214 may provide the payment credential generated based on the user profile data to a payment processing service associated with the transaction validation system 214 in order to authorize the transaction.

At operation 314, the transaction validation system 214 executes the transaction with the merchant within the application executed at the client device 106 based on the transaction credential.

At operation 316, the transaction validation system 214 passes a transaction token to the merchant responsive to the executing the transaction with the merchant within the application, the transaction token comprising a validation.

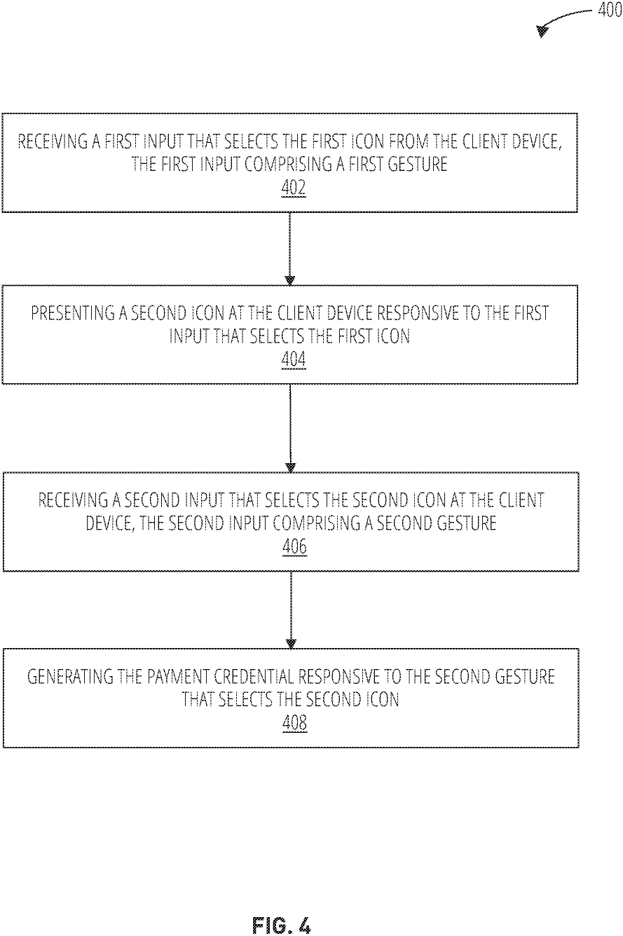

FIG. 4 is a flowchart illustrating operations of a transaction validation system 214 in performing a method 400 for executing and validating a transaction, in accordance with one embodiment. Operations of the method 400 may be performed by one or more subsystems of the messaging system 100 described above with respect to FIG. 2, such as the transaction validation system 214. As shown in FIG. 4, the method 400 includes one or more operations 402, 404, 406, and 408. In certain embodiments, the method 400 may be performed as a subroutine or precursor to one or more operations of the method 300, such as operations 304, 306 and 308.

At operation 402, the transaction validation system 214 receives a first input that selects a first icon presented at a client device 106. For example, as described in operation 304 and 306 of the method 300, the transaction validation system 214 may present an icon (i.e., a first icon) within a GUI of the client device 106. In some embodiments, the first input to select the first icon may be based on a predefined gesture (i.e.,a first gesture). For example, a selection of the first icon may be made based on an input that includes a gesture, such as one or more of a tap, a horizontal swipe, or a vertical swipe.

Responsive to receiving the first input that selects the first icon, at operation 404 the transaction validation system 214 presents a second icon within the GUI of the client device 106. For example, the first icon may initialize a request to execute a transaction, whereas the second icon may confirm the request to execute the transaction.

At operation 406, the transaction validation system 214 receives a second input that selects the second icon at the client device 106, wherein the second input that selects the second icon comprises a gesture (i.e., a second gesture), wherein the gesture includes one or more of a tap, a horizontal swipe, or a vertical swipe.

At operation 408, responsive to receiving the second gesture that selects the second icon, the transaction validation system 214 may generate a payment credential based on the user profile data associated with the user profile. For example, the transaction validation system 214 may accesses the database 122 to retrieve validation credentials associated with a selected payment method to generate the payment credential.

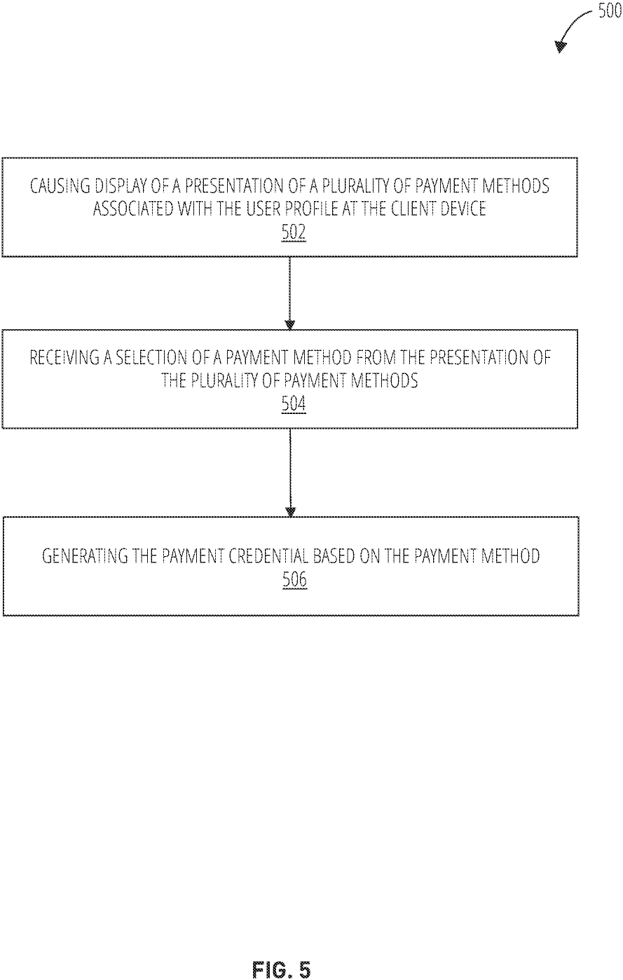

FIG. 5 is a flowchart illustrating operations of a transaction validation system 214 in performing a method 500 for executing and validating a transaction, in accordance with one embodiment. Operations of the method 500 may be performed by one or more subsystems of the messaging system 100 described above with respect to FIG. 2, such as the transaction validation system 214. As shown in FIG. 5, the method 500 includes one or more operations 502, 504, and 506. In certain embodiments, the method 500 may be performed as a subroutine or precursor to one or more operations of the method 300, such as operations 304, and 306.

At operation 502, responsive to receiving an input that selects the icon presented by the transaction validation system 214 within the GUI at the client device 106, the transaction validation system 214 causes display of a presentation of a plurality of payment methods associated with the user profile. For example, responsive to receiving the input that selects the icon, the transaction validation system 214 accesses the database 122 to retrieve and display one or more payments methods associated with the user account.

At operation 504, the transaction validation system 214 receives a selection of a payment method from among the one or more payments methods presented at the client device 106.

Responsive to receiving the input that selects the payment method from among the one or more payments methods, the transaction validation system 214 accesses the database 122 to retrieve validation credentials associated with the selected payment method in order to generate the payment credential.

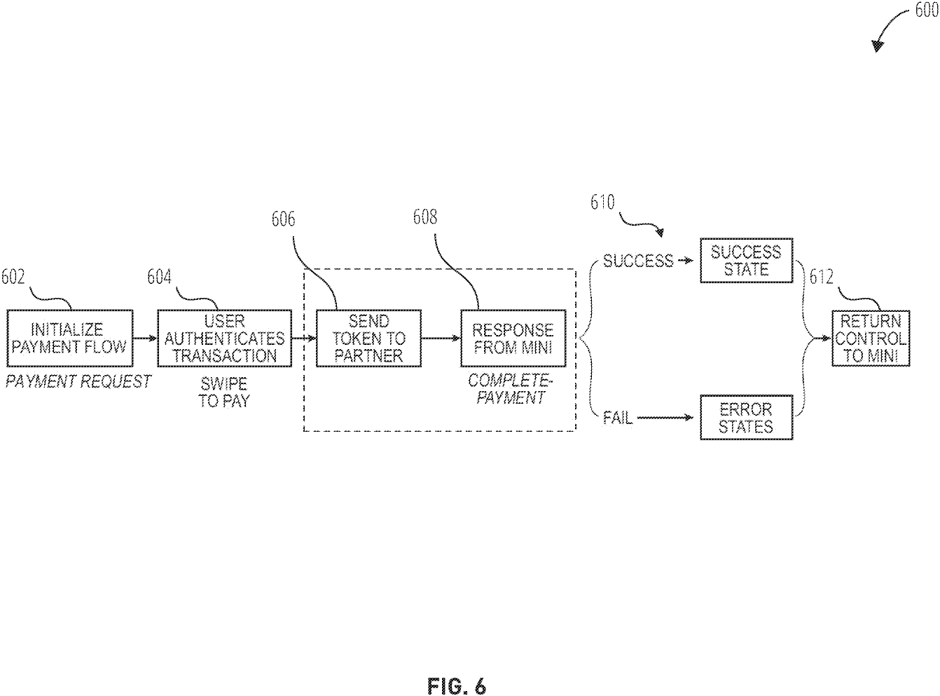

FIG. 6 illustrates a flow diagram 600 depicting a method for facilitating a secure transaction, in accordance with one embodiment.

At operation 602, as discussed in operations 302, and 304 of the method 300 depicted in FIG. 3, and the method 400 depicted in FIG. 4, a user of a client device 106 may initialize a payment request by providing one or more inputs via a GUI presented at the client device 106.

Responsive to receiving the input to initialize the payment request, at operation 604, the user of the client device 106 may provide an input to authenticate the payment request. For example, as described in the method 400, the transaction validation system 214 may provide a GUI wherein a user may provide an input that comprises an input gesture in order to authenticate the payment request (e.g., swipe to pay).

Responsive to authenticating the payment request, the transaction validation system 214 generates a transaction credential based on user profile data from a user profile associated with the client device 106. For example, the user may provide an input that selects a payment method from among the one or more payment methods associated with the user profile, and in response, the transaction validation system 214 may generate a transaction token based on the validation credentials that correspond with the selected payment method from a database 122, wherein the database 122 may be located within a server system associated with the transaction validation system 214.

At operation 606, the transaction validation system 214 passes the transaction token to a merchant/partner identified within the payment request, and at operation 608, the transaction validation system 214 receives a response from the merchant/partner, wherein the response includes an indication of a status of the transaction (i.e., success or fail). At operation 610 the status of the transaction may be transmitted to the client device 106, and at operation 612, the status may be displayed to the user of the client device 106 within a specially configured GUI.

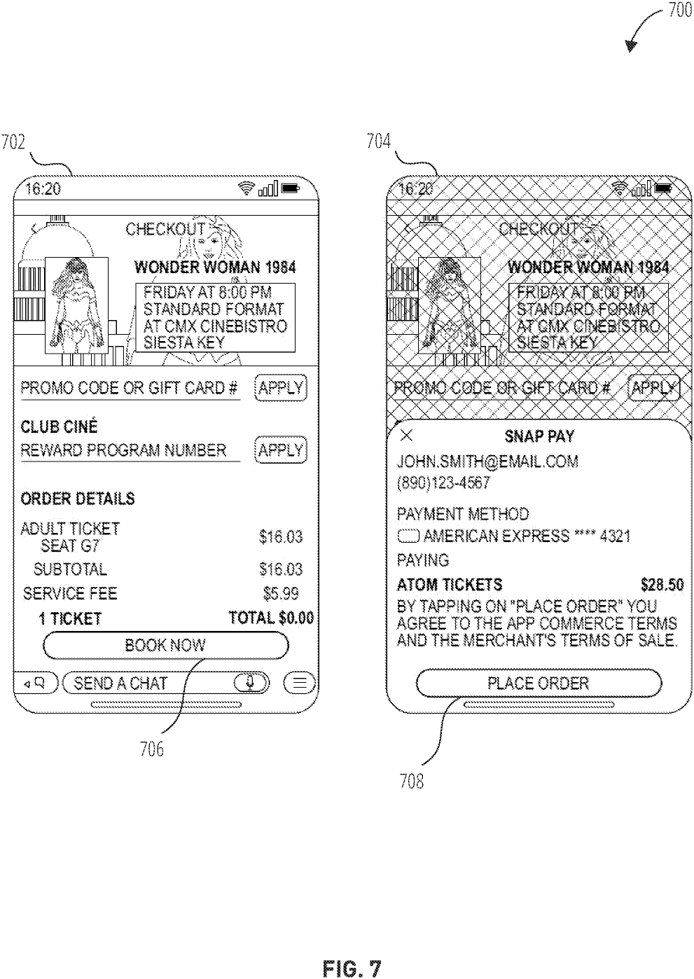

FIG. 7 illustrates an interface flow diagram 700 depicting a method for facilitating a secure transaction, in accordance with one embodiment.

As seen in the interface flow diagram 700, the transaction validation system 214 may generate and display a GUI 702, wherein the GUI 702 includes a display of a first icon 706. For example, as discussed in operation 402 of the method 400, the transaction validation system 214 may receive a first input that selects the first icon 706 from within the GUI 702 in order to initialize a transaction request. In some embodiments, the first input to select the first icon 706 may be based on a predefined gesture such as one or more of a tap, a horizontal swipe, or a vertical swipe.

Responsive to receiving the input that selects the first icon 706, the transaction validation system 214 may display the GUI 704, wherein the GUI 704 includes a second icon 708 to authenticate the initialized transaction request received based on the input that selects the first icon 706. In some embodiments, a user of the client device 106 may provide inputs to specify a payment method via the GUI 704. Accordingly, by providing an input to select the second icon 708, the transaction validation system 214 may access a database 122 to generate a transaction token based on user profile data associated with the user account, and a selected payment method.

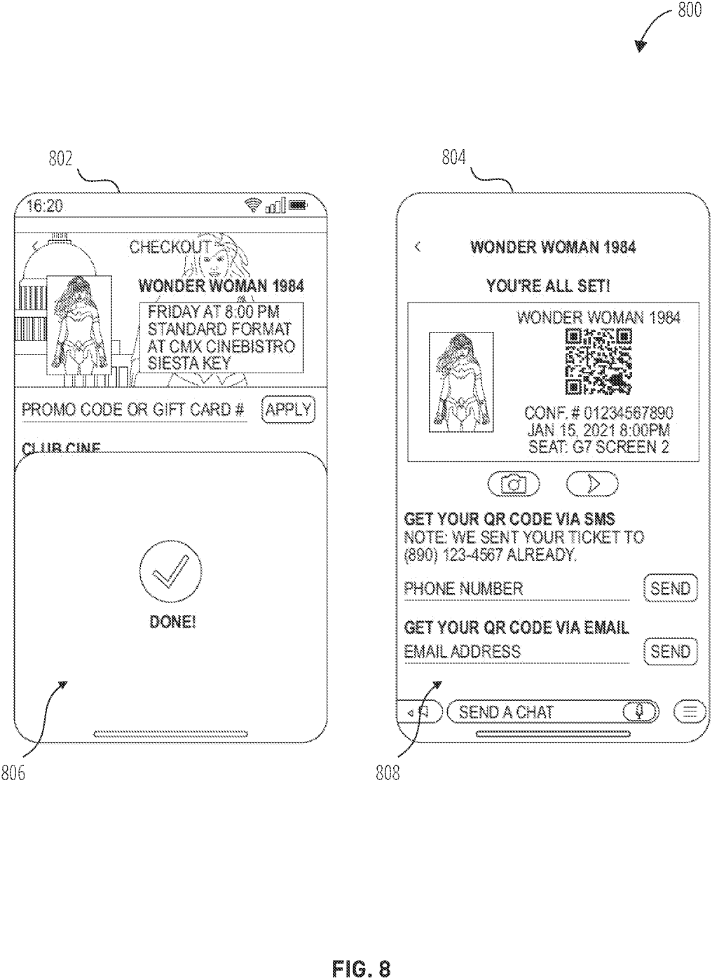

FIG. 8 illustrates an interface flow diagram 800 depicting a method for facilitating a secure transaction, in accordance with one embodiment.

As seen in the interface flow diagram 800, the transaction validation system 214 may display the GUI 802 responsive to receiving a confirmation 806 of a transaction from a merchant/partner. For example, as discussed in the method 300 and 400, responsive to passing a payment token to a merchant/partner, the transaction validation system 214 may receive the confirmation 806 of the transaction from the merchant/partner, and present the confirmation 806 within the GUI 802.

A user may provide a further input to display additional transaction details 808. For example, a user may provide an input that comprises a predefined gesture (i.e., a swipe or tap), and in response, the transaction validation system 214 may display the transaction details 808 within the GUI 804.

### Machine Architecture

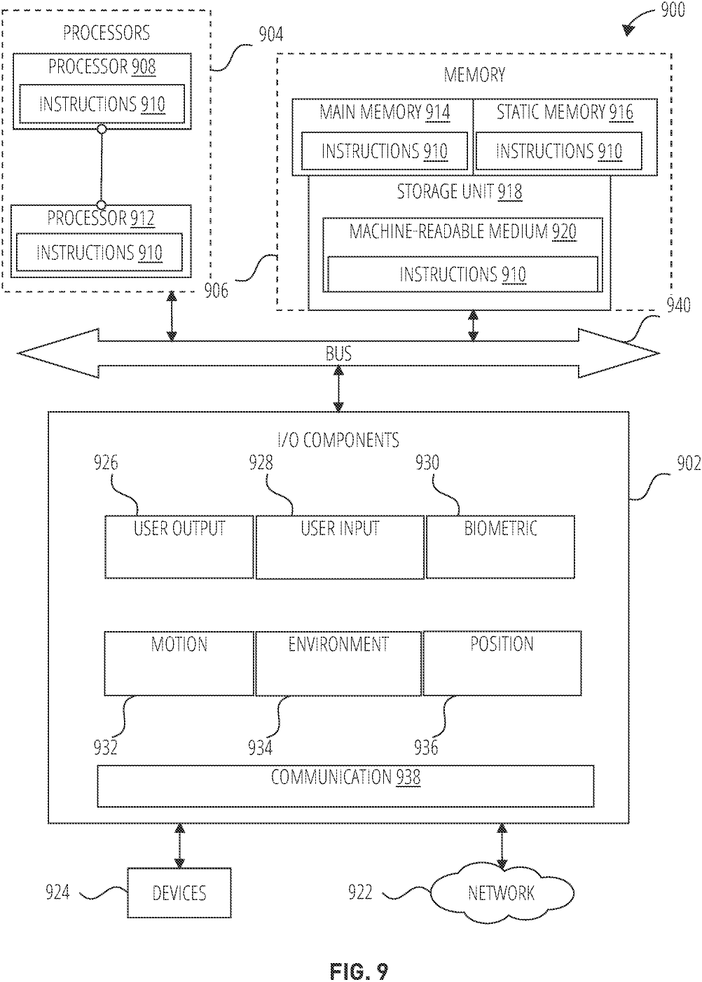

FIG. 9 is a diagrammatic representation of the machine 900 within which instructions 910 (e.g., software, a program, an application, an applet, an app, or other executable code) for causing the machine 900 to perform any one or more of the methodologies discussed herein may be executed. For example, the instructions 910 may cause the machine 900 to execute any one or more of the methods described herein. The instructions 910 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 910, sequentially or otherwise, that specify actions to be taken by the machine 900. Further, while only a single machine 900 is illustrated, the term “machine” shall also be taken to include a collection of machines that individually or jointly execute the instructions 910 to perform any one or more of the methodologies discussed herein. The machine 900, for example, may comprise the client device 106 or any one of a number of server devices forming part of the messaging server system 104. In some examples, the machine 900 may also comprise both client and server systems, with certain operations of a particular method or algorithm being performed on the server-side and with certain operations of the particular method or algorithm being performed on the client-side.

The machine 900 may include processors 904, memory 906, and input/output I/O components 638, which may be configured to communicate with each other via a bus 940. In an example, the processors 904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 908 and a processor 912 that execute the instructions 910. The term “processor” is intended to include multi-core processors that may comprise two or more independent processors (sometimes referred to as “cores”) that may execute instructions contemporaneously. Although FIG. 9 shows multiple processors 904, the machine 900 may include a single processor with a single-core, a single processor with multiple cores (e.g., a multi-core processor), multiple processors with a single core, multiple processors with multiples cores, or any combination thereof.

The memory 906 includes a main memory 914, a static memory 916, and a storage unit 918, both accessible to the processors 904 via the bus 940. The main memory 906, the static memory 916, and storage unit 918 store the instructions 910 embodying any one or more of the methodologies or functions described herein . The instructions 910 may also reside, completely or partially, within the main memory 914, within the static memory 916, within machine-readable medium 920 within the storage unit 918, within at least one of the processors 904 (e.g., within the Processor’s cache memory), or any suitable combination thereof, during execution thereof by the machine 900.

The I/O components 902 may include a wide variety of components to receive input, provide output, produce output, transmit information, exchange information, capture measurements, and so on The specific I/O components 902 that are included in a particular machine will depend on the type of machine. For example, portable machines such as mobile phones may include a touch input device or other such input mechanisms, while a headless server machine will likely not include such a touch input device. It will be appreciated that the I/O components 902 may include many other components that are not shown in FIG. 9. In various examples, the I/O components 902 may include user output components 926 and user input components 928. The user output components 926 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 928 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 902 may include biometric components 930, motion components 932, environmental components 934, or position components 936, among a wide array of other components. For example, the biometric components 930 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 932 include acceleration sensor components (e.g., accelerometer), gravitation sensor components, rotation sensor components (e.g., gyroscope).

The environmental components 934 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 106 may have a camera system comprising, for example, front cameras on a front surface of the client device 106 and rear cameras on a rear surface of the client device 106. The front cameras may, for example, be used to capture still images and video of a user of the client device 106 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 106 may also include a 360° camera for capturing 360° photographs and videos.

Further, the camera system of a client device 106 may include dual rear cameras (e.g., a primary camera as well as a depth-sensing camera), or even triple, quad or penta rear camera configurations on the front and rear sides of the client device 106. These multiple cameras systems may include a wide camera, an ultra-wide camera, a telephoto camera, a macro camera and a depth sensor, for example.

The position components 936 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 902 further include communication components 938 operable to couple the machine 900 to a network 922 or devices 924 via respective coupling or connections. For example, the communication components 938 may include a network interface Component or another suitable device to interface with the network 922. In further examples, the communication components 938 may include wired communication components, wireless communication components, cellular communication components, Near Field Communication (NFC) components, Bluetooth* components (e.g., Bluetooth^{®} Low Energy), Wi-Fi^{®} components, and other communication components to provide communication via other modalities. The devices 924 may be another machine or any of a wide variety of peripheral devices (e.g., a peripheral device coupled via a USB).

Moreover, the communication components 938 may detect identifiers or include components operable to detect identifiers. For example, the communication components 938 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 938, such as location via Internet Protocol (IP) geolocation, location via Wi-Fi® signal triangulation, location via detecting an NFC beacon signal that may indicate a particular location, and so forth.

The various memories (e.g., main memory 914, static memory 916, and memory of the processors 904) and storage unit 918 may store one or more sets of instructions and data structures (e.g., software) embodying or used by any one or more of the methodologies or functions described herein. These instructions (e.g., the instructions 910), when executed by processors 904, cause various operations to implement the disclosed examples.

The instructions 910 may be transmitted or received over the network 922, using a transmission medium, via a network interface device (e.g., a network interface component included in the communication components 938) and using any one of several well-known transfer protocols (e.g., hypertext transfer protocol (HTTP)). Similarly, the instructions 910 may be transmitted or received using a transmission medium via a coupling (eg, a peer-to-peer coupling) to the devices 924.

### Software Architecture

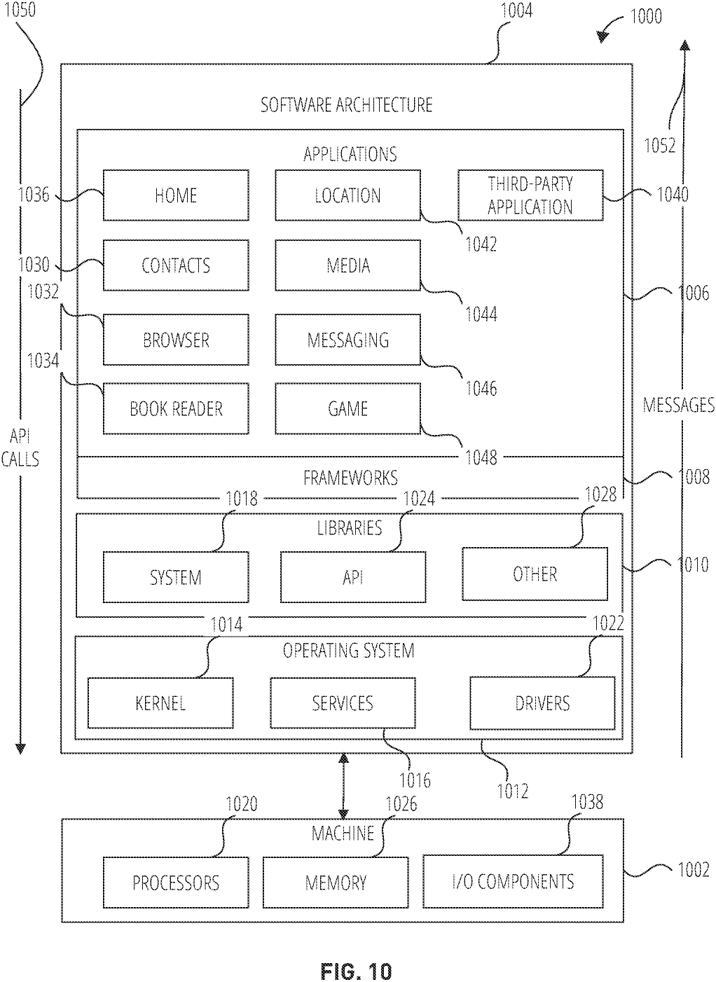

FIG. 10 is a block diagram 1000 illustrating a software architecture 1004, which can be installed on any one or more of the devices described herein. The software architecture 1004 is supported by hardware such as a machine 1002 that includes processors 1020, memory 1026, and I/O components 1038. In this example, the software architecture 1004 can be conceptualized as a stack of layers, where each layer provides a particular functionality The software architecture 1004 includes layers such as an operating system 1012, libraries 1010, frameworks 1008, and applications 1006. Operationally, the applications 1006 invoke API calls 1050 through the software stack and receive messages 1052 in response to the API calls 1050.

The operating system 1012 manages hardware resources and provides common services. The operating system 1012 includes, for example, a kernel 1014, services 1016, and drivers 1022. The kernel 1014 acts as an abstraction layer between the hardware and the other software layers. For example, the kernel 1014 provides memory management, processor management (e.g., scheduling), component management, networking, and security settings, among other functionality. The services 1016 can provide other common services for the other software layers. The drivers 1022 are responsible for controlling or interfacing with the underlying hardware. For instance, the drivers 1022 can include display drivers, camera drivers, BLUETOOTH® or BLUETOOTH® Low Energy drivers, flash memory drivers, serial communication drivers (e.g, USB drivers), WI-FI® drivers, audio drivers, power management drivers, and so forth.

The libraries 1010 provide a common low-level infrastructure used by the applications 1006. The libraries 1010 can include system libraries 1018 (e.g., C standard library) that provide functions such as memory allocation functions, string manipulation functions, mathematic functions, and the like. In addition, the libraries 1010 can include API libraries 1024 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1010 can also include a wide variety of other libraries 1028 to provide many other APIs to the applications 1006.

The frameworks 1008 provide a common high-level infrastructure that is used by the applications 1006. For example, the frameworks 1008 provide various graphical user interface (GUI) functions, high-level resource management, and high-level location services. The frameworks 1008 can provide a broad spectrum of other APIs that can be used by the applications 1006, some of which may be specific to a particular operating system or platform

In an example, the applications 1006 may include a home application 1036, a contacts application 1030, a browser application 1032, a book reader application 1034, a location application 1042, a media application 1044, a messaging application 1046, a game application 1048, and a broad assortment of other applications such as a third-party application 1040. The applications 1006 are programs that execute functions defined in the programs. Various programming languages can be employed to create one or more of the applications 1006, structured in a variety of manners, such as object-oriented programming languages (e.g., Objective-C, Java, or C++) or procedural programming languages (e.g., C or assembly language). In a specific example, the third-party application 1040 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1040 can invoke the API calls 1050 provided by the operating system 1012 to facilitate functionality described herein.

### Processing Components

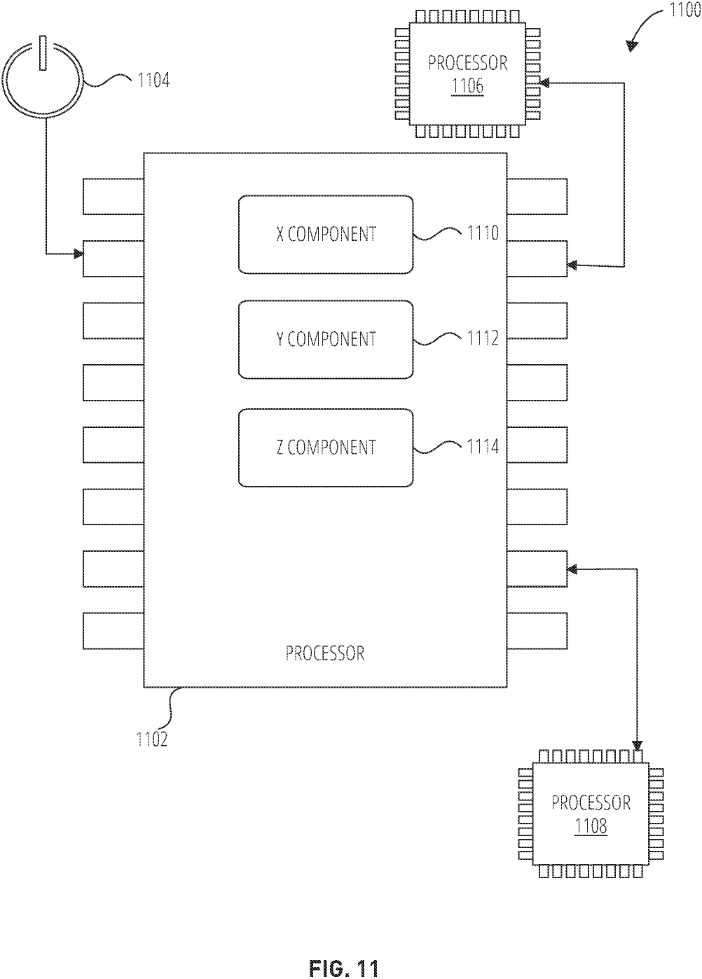

Turning now to FIG. 11, there is shown a diagrammatic representation of a processing environment 1100, which includes a processor 1102, a processor 1106, and a processor 1108 (e.g., a GPU, CPU or combination thereof).

The processor 1102 is shown to be coupled to a power source 1104, and to include (either permanently configured or temporarily instantiated) modules, namely an X component 1110, a Y component 1112, and a Z component 1114, operationally configured to provide a depth estimation and generate a 3D image, in accordance with embodiments discussed herein.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (eg, hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magnetooptical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
executing an application at a client device, the application associated with a merchant;
presenting a graphical user interface (GUI) associated with the application at the client device, the GUI including an icon to initiate a request for a payment to the merchant associated with the application;
receiving an input that selects the icon from the client device;
accessing a user profile associated with the client device in response to the input that selects the icon;
generating a payment credential based on user profile data from the user profile;
authorizing the payment to the merchant based on the payment credential;
executing the payment to the merchant within the application, based on the authorizing the payment; and
passing a payment token to the merchant responsive to the executing the payment to the merchant within the application, the payment token comprising a validation.

2. The method of claim 1, wherein the accessing the user profile associated with the client device in response to the input that selects the icon further comprises:
accessing a database that includes the user profile data responsive to the input that selects the icon from the client device.

3. The method of claim 2, wherein the database includes a third-party database.

4. The method of claim 2, wherein the user profile data associated with the user profile includes a plurality of payment methods associated with the user profile, and the method further comprises:
selecting a payment method from among the plurality of payment methods based on the input that selects the icon from the client device.

5. The method of claim 1, wherein the icon is a first icon, and the receiving the input that selects the icon from the client device further comprises:
receiving a first input that selects the first icon from the client device, the first input comprising a first gesture;
presenting a second icon at the client device responsive to the first input that selects the first icon;
receiving a second input that selects the second icon at the client device, the second input comprising a second gesture; and
generating the payment credential responsive to the second gesture that selects the second icon.

6. The method of claim 1, further comprising:
receiving, at the client device, a confirmation of the payment based on the validation; and
causing display of a presentation of the confirmation at the client device.

7. The method of claim 1, wherein the user profile data associated with the user profile includes a plurality of payment methods associated with the user profile, and the generating the payment credential based on the user profile data from the user profile includes:
causing display of a presentation of the plurality of payment methods associated with the user profile at the client device;
receiving a selection of a payment method from the presentation of the plurality of payment methods; and
generating the payment credential based on the payment method.

8. A system comprising:
a memory; and
at least one hardware processor coupled to the memory and comprising instructions that causes the system to perform operations comprising:
executing an application at a client device, the application associated with a merchant;
presenting a graphical user interface (GUI) associated with the application at the client device, the GUI including an icon to initiate a request for a payment to the merchant associated with the application;
receiving an input that selects the icon from the client device;
accessing a user profile associated with the client device in response to the input that selects the icon;
generating a payment credential based on user profile data from the user profile;
authorizing the payment to the merchant based on the payment credential;
executing the payment to the merchant within the application, based on the authorizing the payment; and
passing a payment token to the merchant responsive to the executing the payment to the merchant within the application, the payment token comprising a validation.

9. The system of claim 8, wherein the accessing the user profile associated with the client device in response to the input that selects the icon further comprises:
accessing a database that includes the user profile data responsive to the input that selects the icon from the client device.

10. The system of claim 9, wherein the database includes a third-party database.

11. The system of claim 9, wherein the user profile data associated with the user profile includes a plurality of payment methods associated with the user profile, and the method further comprises:
selecting a payment method from among the plurality of payment methods based on the input that selects the icon from the client device.

12. The system of claim 8, wherein the icon is a first icon, and the receiving the input that selects the icon from the client device further comprises:
receiving a first input that selects the first icon from the client device, the first input comprising a first gesture;
presenting a second icon at the client device responsive to the first input that selects the first icon;
receiving a second input that selects the second icon at the client device, the second input comprising a second gesture; and
generating the payment credential responsive to the second gesture that selects the second icon.

13. The system of claim 8, further comprising:
receiving, at the client device, a confirmation of the payment based on the validation; and
causing display of a presentation of the confirmation at the client device.

14. The system of claim 8, wherein the user profile data associated with the user profile includes a plurality of payment methods associated with the user profile, and the generating the payment credential based on the user profile data from the user profile includes:
causing display of a presentation of the plurality of payment methods associated with the user profile at the client device;
receiving a selection of a payment method from the presentation of the plurality of payment methods; and
generating the payment credential based on the payment method.

15. A machine-readable storage medium comprising instructions that, when executed by one or more processors of a machine, cause the machine to perform operations comprising:
executing an application at a client device, the application associated with a merchant;
presenting a graphical user interface (GUI) associated with the application at the client device, the GUI including an icon to initiate a request for a payment to the merchant associated with the application;
receiving an input that selects the icon from the client device;
accessing a user profile associated with the client device in response to the input that selects the icon;
generating a payment credential based on user profile data from the user profile;
authorizing the payment to the merchant based on the payment credential;
executing the payment to the merchant within the application, based on the authorizing the payment; and
passing a payment token to the merchant responsive to the executing the payment to the merchant within the application, the payment token comprising a validation.

16. The machine-readable storage medium of claim 15, wherein the accessing the user profile associated with the client device in response to the input that selects the icon further comprises:
accessing a database that includes the user profile data responsive to the input that selects the icon from the client device.

17. The machine-readable storage medium of claim 16, wherein the database includes a third-party database.

18. The machine-readable storage medium of claim 16, wherein the user profile data associated with the user profile includes a plurality of payment methods associated with the user profile, and the method further comprises:
selecting a payment method from among the plurality of payment methods based on the input that selects the icon from the client device.

19. The non-transitory machine-readable storage medium of claim 15, wherein the icon is a first icon, and the receiving the input that selects the icon from the client device further comprises:
receiving a first input that selects the first icon from the client device, the first input comprising a first gesture;
presenting a second icon at the client device responsive to the first input that selects the first icon;
receiving a second input that selects the second icon at the client device, the second input comprising a second gesture; and
generating the payment credential responsive to the second gesture that selects the second icon.

20. The non-transitory machine-readable storage medium of claim 15, further comprising:
receiving, at the client device, a confirmation of the payment based on the validation; and
causing display of a presentation of the confirmation at the client device.
